(19) United States
(12) Patent Application Publication
(10) Pub. No.: US 2007/0121989 A1
(43) Pub. Date: May 31, 2007

(54) Audio output device

(75) Inventor: Junichi Inaba, Tokyo (JP)

Correspondence Address: FOLEY AND LARDNER LLP;SUITE 500, 3000 K STREET NW, WASHINGTON, DC, 20007, US

(73) Assignees: PIONEER CORPORATION; PIONEER DESIGN CORPORATION

(21) Appl. No.: 11/604,394

(22) Filed: Nov. 27, 2006

(30) Foreign Application Priority Data
Nov. 30, 2005 (JP) 2005-346053

(51) Int. Cl. H04R 1/02

(52) U.S. Cl. 381/388; 381/333

(57) ABSTRACT

An audio output device that has the configuration of a slat curtain includes a speaker unit provided in each slat. Therefore if the audio output device is used hanging from a window frame, ceiling, on a wall or any other such structure, the audio output device achieves a function of outputting sound while maintaining the functions of a regular slat curtain, such as the adjustment of natural lighting permitted to pass through the slat curtain and the separation of indoor spacer. Thus, a user is able listen to audio output without conscious awareness of the existence of the audio output device.

### BACKGROUND OF THE INVENTION

1. Field of the Invention

The present invention relates to an audio output device.

2. Description of the Related Art

Conventionally, audio output speakers include, for example, a voice coil, a permanent magnet, and a diaphragm among other components, and have a box-like exterior shape. To achieve an effect of surround sound with such speakers, a plurality of speakers is arranged to encircle a user. Furthermore, in the event low pitched sounds (i.e., bass) are desirable, a separate device such as a woofer is employed.

In addition, conventionally, in a plurality of speaker cabinets, treble, midrange, low midrange, and bass speakers are installed inside each cabinet. On the front of each cabinet, outwardly facing ports at an oblique angle are installed to enable a broader carrying of the sound and within the cabinet, a plurality of acoustic filters are installed to dampen resonance frequencies of sound waves generated toward the back of the speaker. Moreover, on the top and bottom ends of cabinets, saddle brackets and corresponding components are equipped to enable vertical stacking of the cabinets as well as detached arrangement of the cabinets. Japanese Patent Laid-Open Publication No. 2000-308169 is an example for reference.

With conventional technology (inclusive of the above cited example), there are problems in the event of indoor installation, e.g., awareness of the existence of the speaker is said to be accentuated affecting a confined, stifling feeling in the user. Furthermore, in the event a plurality of speakers is arranged in order to obtain the effect of surround sound and a separate woofer is employed to accentuate the bass, the aforementioned effect is intensified.

### SUMMARY OF THE INVENTION

It is an object of the present invention to at least solve a problem in the conventional technologies.

An audio output device according to one aspect of the present invention includes a speaker unit that is provided in each of slats constituting a slat curtain.

The other objects, features, and advantages of the present invention are specifically set forth in or will become apparent from the following detailed description of the invention when read in conjunction with the accompanying drawings.

### BRIEF DESCRIPTION OF THE DRAWINGS

FIG. 1 is a schematic diagram of an audio output device according to an embodiment of the present invention;

FIG. 2 is a schematic diagram of a speaker system according to a first example of the embodiment;

FIG. 3 is a perspective view of a portion of the speaker system;

FIG. 4 is a sectional view illustrating a structure of a speaker unit;

FIG. 5 is a block diagram of the speaker system;

FIG. 6 is a reference drawing that illustrates an application example of the speaker system; and

FIG. 7 is a front view of a speaker unit according to a second embodiment of the present invention.

### DETAILED DESCRIPTION OF THE PREFERRED EMBODIMENTS

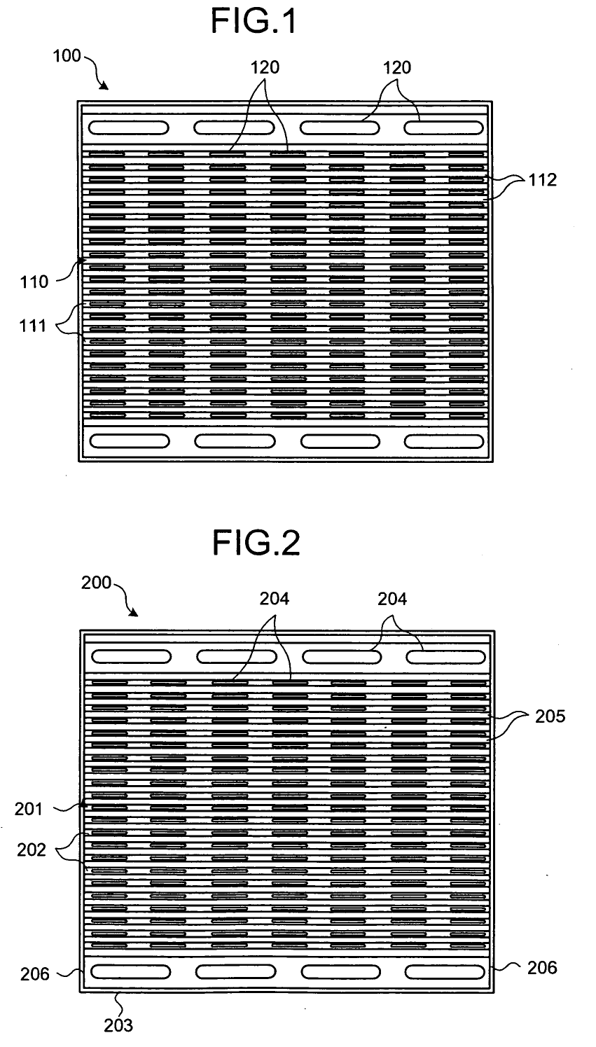

Exemplary embodiments according to the present invention will be explained in detail with reference to the accompanying drawings. FIG. 1 is a schematic diagram of an audio output device according to embodiments of the present invention. As illustrated in FIG. 1, an audio output device 100 according the exemplary embodiments includes a speaker unit 120 that is installed in a slat 111. The slat 111 constitutes a part of a slat curtain 110.

The slat curtain 110 includes a plurality of slats 111. More specifically, for example, the slat curtain 110 may be a set of blinds, shutters, and alternatively any other such structure. The slats 111 of the slat curtain 110 are arranged intermittently in an identical plane, such that opposing longitudinal ends of each slat 111 are aligned with opposing longitudinal ends of adjacent slats 111 to form an array. As a result, a gap 112 between the slats 111 is created.

The slat curtain 110, for example, is able to be installed and utilized along a window. Thus, natural light enters a room through the gaps 112 in the slat curtain 110. When window is opened, introduction of outdoor air through the gaps 112 is possible. Furthermore, utilization of the slat curtain 110, for example, is also possible wherein the slat curtain 110 is hanging from the ceiling of a room. In this case, despite a division of the room by the slat curtain 110, the ambience of the entire room is able to be gained through the gaps 112.

The slats 111 may be enabled to slide along the plane in which the slats 111 are arranged in the slat curtain 110, in a direction that is not parallel to the longitudinal axis of the slat 111 formed by a straight line connecting the center of two opposing longitudinal ends of the slats 111. In this case, the slats 111 may slide independent of one another. Alternatively, with one action, all of the slats 111 may slide simultaneously. The gap 112 between the slats 111 expands and contracts corresponding to the direction of movement of the slats 111.

Meanwhile, the slats 111 may be constructed of an optically transparent material. In this case, in an open space, such as a room, that is divided by the slat curtain 110, regardless of the presence of the gaps 112 in the slat curtain 110, natural light is able to pass from one side of the divided space to another by passing through the slat curtain 110.

The speaker unit 120 is an audio output component, and includes a speaker and an amplifier. The amplifier of the speaker unit 120 may be constructed to enable the output audio range, volume, and alternatively output timing and such to be controlled. In this case, a control unit to control each amplifier may be integrated into the audio output device 100, and alternatively, it may be separately installed. This type of speaker unit 120, specifically, for example, is compatible with the Pioneer Digital Sound Processor (PDSP), a product manufactured by Pioneer Corporation.

The speaker unit 120 is provided such that between speaker units 120, the gap 112 is created. In the event that a plurality of speaker units 120 is installed in a single slat 111, a space (reference symbol omitted) between each of the speaker units 120 in the single slat 111 may also be created.

The speaker units 120 are provided such that output of each speaker unit 120 is from an identical plane. Specifically, the speaker units 120 are aligned such that the speakers equipped in the speaker unit 120 are positioned in the same plane. The plane of audio output is parallel to the plane formed by the slats 111 of the slat curtain 110, and alternatively, it may be an identical plane.

The direction of audio output from the speaker unit 120 may be variable for each of the slats 111. Specifically, the slat 111 is constructed to enable rotation thereof such that the front and the rear are reversible. As a result, when a portion of the slats 111 in the slat curtain 110 is rotated, the direction of audio output is switched enabling audio output to be delivered to both sides of the slat curtain 110.

The speaker units 120 may vary in size among slats 111. The size of the speaker unit 120, for example, varies according to the audio range to be output. Specifically, speaker unit 120 size is increased until low range output is accommodated. In this case, according to the size of the speaker unit 120, an increase in the size of the slat 111 arrangement is desirable in the columnar direction of the array.

The size of the slats 111 may vary according to the size of the speaker unit 120. Specifically, the size of the slat 111 in which a large-sized speaker unit 120 is installed is increased according to the size of the speaker unit 120. The size of the slats 111 may also vary according to the weight of the speaker unit 120. Furthermore, in the event a plurality of speaker units 120 is installed in a single slat 111, the size of the slat 111 may vary according to the quantity of speaker units 120 installed.

The slat curtain 110 may be constructed to be rolled up and unrolled. For example, the slat 111 positioned at an end of the array of slats 111 in the slat curtain 110 can serve as an axis for the slat curtain 110 to be rolled up around. In this case, of the slats 111 rolled up, a slat at an exterior end of the slat curtain 110 is pulled, thereby enabling a sequential release of the interconnected slats 111 and unrolling of the slat curtain 110. Rolling and unrolling of the slat curtain 110 may be conducted manually or automatically by electrical and other means.

As described above, with the audio output device 100, the speaker units 120 are provided in each of the slats 111 constituting the slat curtain 110, thereby enabling the audio output device 100 to be handled in a similar manner to the slat curtain 110. Therefore, in the event that the audio output device 100 is hung on a wall, from a window frame, a ceiling, and any other such structure, a function similar to that of the slat curtain 110 can be realized in conjunction with audio output, thereby enabling a user to listen to audio output without conscious awareness of the existence of the audio output device 100.

Further, with the audio output device 100, there are gaps 112 between the speaker units 120. As such, in a space divided into two subspaces by the slat curtain 110, light and sound can pass to and from either subspace through the gaps 112. Therefore, through the audio output device 100, the conditions on one side of a space divided by the slat curtain 110 is able to be conveyed to a user on the other side of the slat curtain 110, thereby enabling a user to be aware of the ambience of a subspace on an opposing side of the audio output device 100. Hence, without a stifling or confined feeling, the user is able to listen to audio output.

In addition, with the audio output device 100, the slats 111 slidable and by the sliding action of the slats 111, the size of the gap 112 is adjustable. Therefore, the audio output device 100 outputs sound while realizing the function of the slat curtain 110 in which the degree of natural lighting allowed to pass is adjusted by the size of the gap 112. As a result, a user can listen to audio output while utilizing the function of the slat curtain 110.

Further, with the audio output device 100, the speaker unit 120 is provided such that audio output is from an identical plane, which, for example, enables planar installation of the audio output device 100 along a window, a wall, a ceiling, and other such structures. Therefore, audio output is possible without the installation of the audio output device 100 affecting a user impact much different from that derived from such structures as a window, a ceiling, and a wall. As a result, a user is able to listen to audio output without any sense of incongruity in ambience.

Moreover, with the audio output device 100 according to the exemplary embodiment, the speaker unit 120 is provided to enable the direction of audio output to be switched by the slat 111. As such, output direction is variable by the slat 111. Therefore, with the audio output device 100, a plurality of output directions is possible. As a result, in a space divided by the slat curtain 110, the same audio output can be heard by a user on either side of the slat curtain 110.

Also, with the audio output device 100 according to the exemplary embodiment, the size of the speaker unit 120 varies among slats 111. Hence, a size for the speaker unit 120 can be adopted according to output audio range, thereby enabling the audio output device 100 to deliver a wide spectrum of audio ranges, and consequently enabling a user to listen to a wide spectrum of audio ranges without being conscious of the existence of the audio output device 100.

Furthermore, with the audio output device 100, the size of the slat 111 varies according to the size of the speaker unit 120. Hence, regardless of the output audio range, the speaker unit 120 can be stable and supported, and the audio output device 100 can deliver a stable, expansive scope of audio ranges, factors that consequently enable a user to listen to a wide spectrum of audio ranges with peace of mind.

In addition, with the audio output device 100, the slat curtain 110 can be rolled up and unrolled. As such, for example, depending on the needs of a user, the form of the slat curtain 110 is changeable. Therefore, for example, utilization, wherein the audio output device 100 is kept rolled up except during periods of use, is possible. As a result, a user is able to enjoy the slat curtain 110 function while listening to the audio output.

A first example of the embodiment is an application of the aforementioned audio output device 100 according to the embodiment as a speaker system installed indoors. First, an exterior of the speaker system of the first example shall be described. FIG. 2 is a schematic diagram illustrating a speaker system 200 of the first example. As shown in FIG. 2, the speaker system 200 includes a plurality of slats 202 that constitute a slat curtain 201, a frame 203 that supports the slats 202, and a speaker unit 204 that is provided in the slats 202.

Next, the slat 202 shall be described. Each of the slats 202 of the slat curtain 201 has a long and narrow configuration. In each of the slats 202, each of the speaker units 204 that includes a speaker and an amplifier (not illustrated in FIG. 2) are provided. The slats 202 are arranged in an array such that the slats 202 are longitudinally parallel. The slats 202 are positioned intermittently, and as a result, a gap 205 is formed between the slats 202. Open space on opposing sides of the speaker system 200 that face the length of the slats 202 is connected by the gaps 205.

The frame 203 is a support structure that encompasses the perimeter of the speaker system 200. The frame 203 supports the slats 202 by sandwiching the slats 202 with a support 206 that is coupled to the frame 203 and runs facing the opposing longitudinal ends of the slats 202.

Specifically, for example, provided on each opposing longitudinal end portion of the slats 202 is a male component of a connecting fixture (not illustrated in figure) that protrudes in the direction of the support 206. At the same time, along the length of the support 206 is a plurality of female components that correspond to the connecting fixture (not illustrated in figure) provided on the slats 202. By engaging the male and female components of the connecting fixture, the slats 202 can be supported in particular positions. In this case, the position of each slat 202 along the length of the support 206 is determined by the position of the female components along the length of the support 206.

Furthermore, the frame 203 supports the slats 202 such that the slats 202 are able to rotate about an imaginary longitudinal axis. Specifically, for example, in the event that the slats 202 are supported by the aforementioned method, the slat 202 is rotatable about a longitudinal axis that is formed by a straight line passing through the two points of the connecting fixture engagement specific to the slat 202.

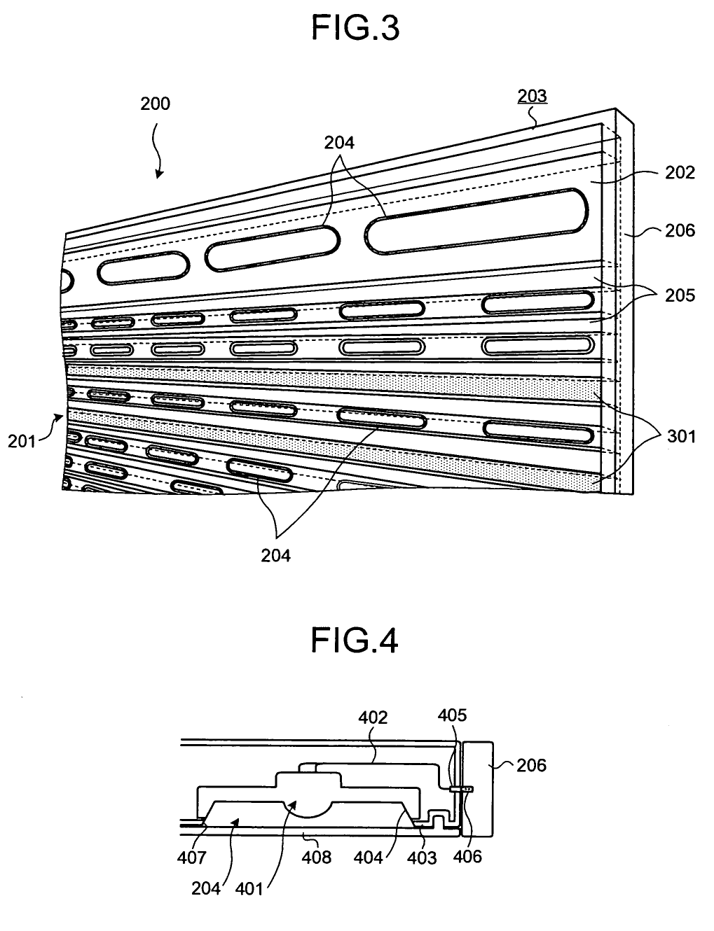

Each of the slats 202 is independently rotatable. As such, a portion of the total slats 202 can be rotated. FIG. 3 is a perspective view of a portion of the speaker system 200 and illustrates a portion of the slats 202 in a rotated condition. Regarding the position of a speaker in the speaker unit 204 that is installed in a rotated slat 301, wherein the rotated slat 301 has been rotated 180 degrees, the speaker assumes an orientation that is 180 degrees from its initial orientation. In other words, the audio output of the speaker unit 204 in the 180 degree-rotated slat 301 is oriented 180 degrees opposite that of the speaker unit 204 in a slat 202 that is oriented in an identical direction as the initial direction of the rotated slat 301 prior to rotation.

Moreover, the frame 203 supports the slats 202 such that each slat 202 is able to slide along the length of the support 206. Specifically, for example, the support 206 is provided with a rail (not illustrated in figure) that runs along the length of the support 206. In this way, opposing longitudinal ends of the slat 202 are guided along the rail, thereby, enabling the slats 202 to slide along the length of the support 206.

For example, if each slat 202 is connected to the support 206 by the aforementioned connecting fixture, the connecting fixture may be constructed such that in the event an external force applied against the slat 202 exceeds a given intensity, the connecting fixture is disengaged. Specifically, for example, the male component of the connecting fixture and alternatively, the support 206 may be constructed of a flexible material. Hence, by a deformation of the male component and alternatively, of the support 206, the connecting fixture is disengaged.

Furthermore, the speaker system 200 includes a motor (omitted from FIG. 2) to initiate a motive force to rotate and slide the slats 202 (refer to FIG. 5) as well as a mechanism to transfer the motive force of the motor to each slat 202.

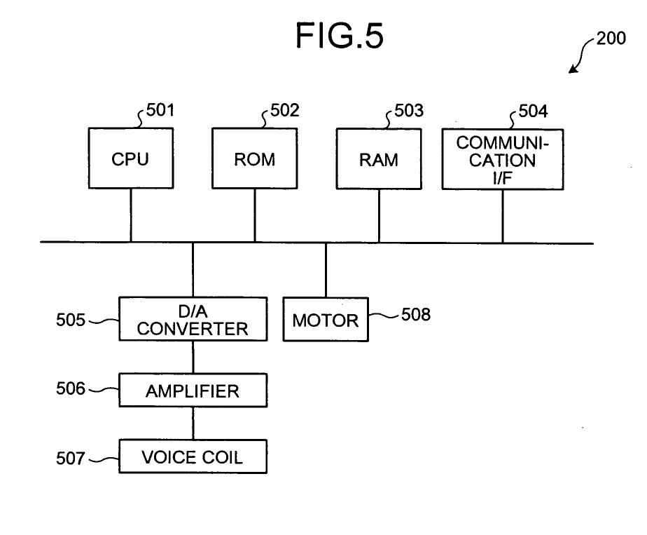

Also, the frame 203, for example, is constructed of an optically transparent material that has a transparency similar to that of glass, plastic, and other such materials. Wiring to provide power and control signals for each of the speaker units 204 is installed in the frame 203 (refer to FIG. 4). Further, this wiring is also constructed of an optically transparent material that has a transparency similar to that of glass, plastic, and other such materials.

In the frame 203, a contact for the speaker (frame contact 406) is provided in positions to correspond to the slats 202 (refer to FIG. 4). The frame contact 406, through the support of the slats 202 by the support 206, forms an electrical connection with a contact for the frame 203 (a speaker contact 405) that is provided on each slat 202 (refer to FIG. 4), and distributes power and control signals for each slat 202 to the speaker unit 204.

Each slat 202 is assigned an identification code and based on this identification code, power and control signals are distributed to the target slat 202. In this case, the slat 202 is assigned the position where the speaker contact 405 and the frame contact 406 make contact and as such, even in the event that the slat 202 has slid along the support 206, regardless of the position of the frame contact 406, the control signal is able to be sent to the target slat 202.

In addition, an identification code may be assigned for each frame contact 406 and based on the position of each frame contact 406, control signals are delivered to the target speaker unit 204. In this case, without differentiating the speaker contacts 405 provided on the slats 202, control signals are distributed according to the position of the frame contact 406.

Further, distribution of control signals may also be conducted by identification of each frame contact 406 and each slat 202. In this case, when the speaker contact 405 provided in a particular slat 202 makes contact with a particular frame contact 406, control signals are distributed to the target slat 202. Limited to the event wherein the each slat 202 is positioned in a given position, the speaker unit 204 in the slat 202 can be controlled to output sound. As a result, for example, in the event given speaker units 204 are dedicated to given audio ranges, each speaker unit 204 can be reliably controlled.

The speaker units 204 are provided in one slat 202. A speaker and an amplifier (not illustrated in the figure) are each included in the speaker unit 204. The arrangement of the speaker units 204 within a single slat is such that the speakers are positioned in the same plane. A surface of the each speaker unit 204, i.e., the surface wherein the speakers are facing exteriorly relative to the speaker system, is covered by a speaker grill net 408 (refer to FIG. 4). Furthermore, the grill net 408 may cover an aspect of speaker system 200, i.e., the aspect wherein the speakers of the speaker units 204 are facing exteriorly relative to the speaker system.

Further, size of the speaker unit 204 varies according to the output audio range. Specifically, the lower the audio range to be output by the speaker unit 204, the greater the size of the speaker unit 204. Specifically, for example, the technology utilized by the PDSP unit is applicable for use as the speaker unit 204. The speaker unit 204 that applies the technology employed by the PDSP unit shall be herein described for the first example.

FIG. 4 is a sectional view of the speaker unit 204 along the length of the slat 202. The speaker unit 204 includes a PDSP unit 401, a speaker wiring 402, and a speaker cabinet 403.

The PDSP unit 401 includes a permanent magnet, a diaphragm, a voice coil, and an amplifier, and outputs the audio signal that is amplified by the amplifier as sound from a speaker 404 (refer to FIG. 5). Specifically, with the PDSP unit 401, an audio signal that is in the form of an electrical current is applied to a voice coil and a magnetic force is induced, the interaction between the induced magnetic force and the magnetic field of a permanent magnet that surrounds the voice coil, oscillates a diaphragm and consequently air is vibrated resulting in the output of sound.

The speaker wiring 402 connects the amplifier and the speaker contact 405. The speaker contact 405 is provided on the slat 202. The slat 202 is supported by the support 206, which is coupled to the frame, and hence, the speaker contact 405 is connected with the frame contact 406. In this way, an electrical connection is made between the speaker contact 405 and the frame contact 406. Also, in FIG. 4, the wiring (omitted from the figure) runs in a plane perpendicular to aspect of the slat 202 depicted in the figure.

The speaker cabinet 403 houses the PDSP unit 401, the speaker wiring 402 and other such parts. An inlet is provided in a portion of the speaker cabinet 403 where the speaker 404 is located.

Next, each of the electrical connections included in the speaker system 200 shall be described. FIG. 5 is a block diagram illustrating each of the electrical connections. As illustrated in the figure, the speaker system 200 includes a central processing unit (CPU) 501, a read only memory (ROM) 502, a random-access memory (RAM) 503, a communication interface (I/F) 504, a digital/analog (D/A) converter 505, an amplifier 506, a voice coil 507, and a motor 508. Although not illustrated in FIG. 5, the D/A converter 505, the amplifier 506, and the voice coil 507 are each provided in the PDSP unit 401.

The CPU 501 governs overall control of the speaker system 200. The ROM 502 records various control programs. Further, the RAM 503 is used as the work area of the CPU 501. In other words, while using the RAM 503 as a work area, the CPU 501 refers to various data recorded in the ROM 502 and implements various programs to govern overall control of the speaker system 200.

Furthermore, the ROM 502 stores control data employed when movement of the slats 202, e.g., sliding, rotation, is conducted. Specifically, in the event that control signals are distributed based on identification codes assigned to each slat 202 as mentioned above, the ROM 502 stores the identification code of each slat 202 and control data that indicates the sequence of the slats 202 in the speaker system 200. On the contrary, in the event that control signals are distributed based on the position of each frame contact 406, the ROM 502 records the identification code for each of the frame contacts 406 and control data that indicates the sequence of the frame contacts 406 in the support 206.

In addition, in the event that distribution of the control signal wiring is conducted by identification of each frame contact 406 and each slat 202, wherein the speaker contact 405 provided in a particular slat 202 makes contact with a particular frame contact 406 to control signal distribution, the ROM 502 records the identification code of each slat 202, the identification code of each frame contact 406, and control data that indicates the sequence of the frame contacts 406 in the support 206.

Content-related data is associated with the control data of the ROM 502. Content-related data, for example, includes information indicating the genre of the audio output. Specifically, for example, “Classical”, “Japanese Pop”, “Children's Narrative” and such classifications are included. The CPU 501 refers to the data associated with the control data that is stored in the ROM 502 and adjusts the arrangement and audio output direction of each slat 202.

For example, in the event the genre of audio output is “Classical”, the arrangement and audio output direction of each slat 202 is adjusted such that sound can be heard coming from all around a user as in a concert hall. Furthermore, for example, in the event the audio output is a “Children's Narrative”, the arrangement and audio output direction of each slat 202 is adjusted such that the sound comes from in front of a user as if a story teller is speaking.

The communication I/F 504, for example, receives various instructions, such as audio output instructions and instructions regarding arrangement of the slats 202, that are input via a remote controller (not illustrated in FIG. 5). Instructions regarding the arrangement may be instructions for the sliding of the slats 202 along the support 206, or for the rotation of a slat 202 in a particular position.

For example, in the event instructions are received by the communication I/F 504 regarding slat 202 arrangement, the CPU 501 controls the motor 508 according to the instructions, and slides and rotates the slats 202. When sliding and rotating each slat 202, the CPU 501 refers to the control data stored in the ROM 502.

In addition, the communication I/F 504, for example, is connected to an audio signal transmitting device, such as a compact disc (CD) player, and via cable or wireless communication, receives the audio signals transmitted by the device. The CPU 501, based on the audio signal received by the communication I/F 504, generates a digital signal to which audio output quality, output timing and other such properties has been coupled. The generated digital signal is sent to the D/A converter 505 of the PDSP unit 401.

The D/A converter 505 converts the digital signal sent by the CPU 501 into an analog signal and sends it to the amplifier 506. The amplifier 506 amplifies the analog signal sent by the D/A converter 505 and sends it to the voice coil 507. The voice coil 507 vibrates at an amplitude corresponding to the analog signal sent by the amplifier 506, thereby generating audio output.

In addition, each component involved in the control of the PDSP unit 401, such as the CPU 501, the ROM 502, the RAM 503, and the communication I/F 504 among other parts, may be provided on the frame 203 for integration of the speaker system 200. The aforementioned parts may also be separate entities connected by cables and other such wiring.

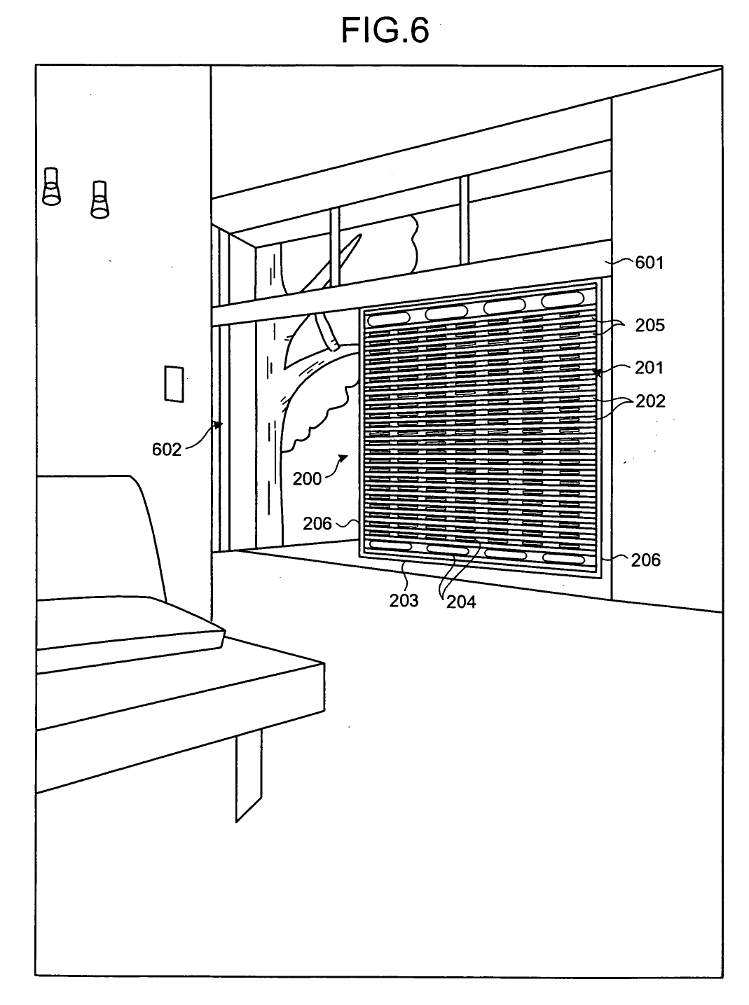

FIG. 6 illustrates an example of application of the speaker system 200, wherein the speaker system 200 is hung in a room from a frame 601 of a window 602. In this case, sunlight passing through the window 602 passes through the gaps 205 in the speaker system 200 and enters the room. In the event that the window 602 is opened, fresh, outdoor air may also be introduced into the room.

In this way, the sun light entering the room can to be softened. By sliding the slats 202 to adjust the gap 205 size, the amount of natural lighting is adjustable. For example, by moving all of the slats 202 to one side, creation of a single large gap is possible. By rotating a portion of the slats 202 in the array such that the speakers 404 are facing outdoors, indoor and outdoor audio output is possible.

In the event that the speaker system 200 is hung from an arbitrary position on a ceiling (omitted from figure), with the speaker in the center, division of a room into two subspaces by the speaker system 200 is possible. In this case, through the gaps 205 in the speaker system 200, a user in a subspace on one side of the speaker system 200 can get a feeling for the ambience of the subspace on the opposing side as well. Specifically, a user on one side, for example, through the gaps 205, is able to see the layout of the subspace on the opposing side, hear sounds emanating from there and know what event is taking place there.

By sliding the slats 202 and widening the size of the gap 205, a user on one side of the speaker system 200 is able to get a better understanding of the conditions on the opposing side. Furthermore, a portion of the array of slats 202 can be rotated such that the speakers 404 contained in the rotated slats 202 face the opposite direction, thereby enabling audio output to both subspaces of the speaker. Therefore, a user on either side of the speaker system 200 can equally enjoy excellent sound quality.

As mentioned above, with the speaker system 200 of the first example, each of the slats 202 that compose the slat curtain 201 is provided with speaker units 204, thereby enabling the speaker system 200 to be handled like the slat curtain 201. Therefore, in the event that the speaker system 200 is hung from the window frame 601, a ceiling, on a wall, and any other such structure, functions similar to those of the slat curtain 201, such as adjustment of natural light entering a room, division of open space, among other functions can be realized along with audio output, thereby enabling a user to listen to audio output without being consciously aware of the existence of the speaker system 200.

Further, with the speaker system 200 of the first example, as there are gaps 205 between the speaker units 204, light, sound and such entities is able to pass back and forth through the gaps 205 to either side of the slat curtain 201. Hence, when used as the slat curtain 201 to divide a space, the speaker system 200 is able to convey the appearance of the space on the side of the slat curtain 201 opposing the side of a user. In this way, a user is able to get a feeling for the ambience of the subspace on the other side of the speaker system 200 and hence, a user is able to listen to audio output without a confined a feeling.

In addition, with the speaker system 200 of the first example, the ability of the slats 202 to slide along the support 206 enables adjustment of the gap 205 size, thereby affording the speaker system 200 with the function of the slat curtain 201, e.g., the adjustment natural light permitted to pass via adjustment of the size of the gap 205 in addition to the function of audio output. In this way, a user is able to utilize the speaker system 200 as the slat curtain 201 while listening to audio output.

Moreover, with the speaker system 200 of the first example of the exemplary embodiment, for example, the degree of freedom in slat layout can be improved such as by sliding the slats 202 to an optimal position to suit utilization needs. In this way, a user is able to freely layout the slats 202 according to preference, intended purpose and other such factors. Furthermore, for example, by moving all of the slats 202 toward the one side of the slat curtain 201 when not in use, any confined feeling affected by the speaker system 200 can be further reduced, thereby enabling a user to enjoy the function of a slat curtain, while listening to audio output.

Also, with the speaker system 200 of the first example, the speaker units 204 are provided such that the audio output of each speaker unit 204 is from an identical plane, enabling, for example, planar installation along the window 602, a wall, a ceiling and other such structures. Therefore, the speaker system 200, for example, can conduct audio output without affecting much of a difference in the impact derived from its installation compared to the impact derived from the window 602, a wall, a ceiling and any other such structure. In this way, a user, without any sense of incongruity in ambience caused by the installation of the speaker system 200, is able to listen to the audio output of the speaker system 200.

Furthermore, with the speaker system 200 of the first example, the speaker units 204 are provided such that their audio output direction is changeable among slats 202, i.e., output direction is variable among slats 202, thereby enabling the speaker system 200 to output sound in a plurality of directions. Hence, with utilization of the speaker system 200 as the slat curtain 201 to divide a space, a user on either side of the speaker system 200 is able to listen to the same audio output without any sense of confinement caused by the installation of the speaker system 200.

In addition, with the speaker system 200 of the first example, the size of the speaker unit 204 varies among the slats 202. As such, a size for the speaker unit 204 corresponding to the output audio range can be adopted, thereby enabling the speaker system 200 to output a wide spectrum of audio ranges. Hence, a user is able to listen to a wide spectrum of audio ranges without conscious awareness of the existence of the speaker system 200.

Further, with the speaker system 200 of the first example, the slat 202 varies in size according to the size of the speaker unit 204. As such, regardless of the output audio range, the speaker unit 204 can be stable and supported, thereby enabling the speaker system 200 to deliver a stable, expansive scope of audio ranges. As a result, a user is able to listen to a wide spectrum of audio ranges with peace of mind.

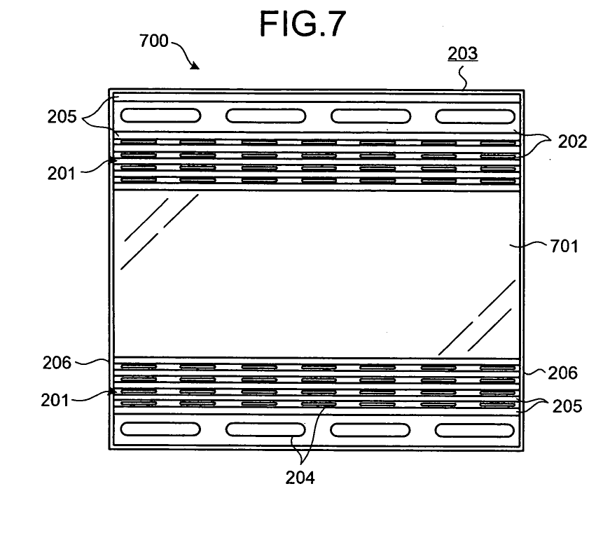

A second example of the embodiment shall be described, wherein the audio output device 100 according to the embodiment is applied as a display device. A portion of the reference characters are identical to those in the aforementioned first example and their description is omitted. FIG. 7 is a front view of a speaker according to the second example.

As show in FIG. 7, a display device 700 includes slats 202 that compose the slat curtain 201, the frame 203 that supports the slats 202, the speaker unit 204 that is provided in the slats 202, and a display 701. For the display 701, for example, a plasma display, a liquid crystal display, an organic light emitting display, and any other such flat-panel type display may be employed.

Although not illustrated in the figure, the display device 700 includes the parts illustrated in FIG. 5 and an image I/F that controls the motor drive of the display 701. The image I/F is connected to the display 701. The image I/F, for example, includes a graphic controller that conducts overall control of the display 701, a memory such as video RAM (VRAM) that temporarily stores instantaneously displayable image data, and a control integrated circuit (control IC) that controls image display of the display 701 based on image data output from the graphic controller.

Furthermore, information regarding the contents to be displayed on the display 701 is associated with control data that is stored by the ROM 502. Content related information, for example, includes a genre of the contents to be displayed on the display 701. For example, for a content genre called “sports” that is categorized, the CPU 501 adjusts the position and direction of audio output of each slat 202 such that audio output can be heard coming from all around a user as if the user were sitting in the stands of a sports arena. For example, for a content genre called “news” that is categorized, the CPU 501 adjusts the position and direction of audio output of each of the slats 202 such that audio output is able to be heard coming from in front of a user as if a news caster were sitting in front of the user.

Content related information may be set according to content genre. It may also be set according to content. For example, for the same “news” genre, the position and direction of audio output of each slat 202 may be adjusted such that the origin of sound corresponds to the situation in which the news is being reported, e.g., a studio broadcast, a live onsite report, and other such situations.

As mentioned above, with the display device 700 of the second example, wherein the display device 700 divides a space into two subspaces, the ambience of each of the subspaces can be shared between the subspaces through the gaps 205. Therefore, even in the event that the display 701 with a large display surface area is employed, the sense of confinement affected the installation of the display device 701 can be reduced.

As described above, with the speaker system 200 of the first example and the display device 700 of the second example, a user is able to listen to audio output without conscious awareness of the existence of the speaker system 200 or the display device 700.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

The present document incorporates by reference the entire contents of Japanese priority document, 2005-346053 filed in Japan on Nov. 30, 2005.

What is claimed is:

1. An audio output device comprising a speaker unit that is provided in each of slats constituting a slat curtain.

2. The audio output device according to claim 1, wherein a gap is provided between the speaker units.

3. The audio output device according to claim 2, wherein the slats are slidably arranged such that a size of the gap increases and decreases.

4. The audio output device according to claim 1, wherein audio output of the speaker unit is from an identical plane.

5. The audio output device according to claim 1, wherein a direction of audio output is changeable by each of the slats.

6. The audio output device according to claim 1, wherein a size of the speaker unit varies among the slats.

7. The audio output device according to claim 6, wherein a size of the slat varies according to the size of the speaker unit.
